(19) United States
(12) Patent Application Publication
(10) Pub. No.: US 2011/0024103 A1
(43) Pub. Date: Feb. 3, 2011

(54) METHOD AND APPARATUS FOR PROVIDING A CONDUCTOR IN A TUBULAR

(76) Inventors: Bruce H. Storm, JR., Houston, TX (US); Eugene Andrew Murphy, Houston, TX (US); Haoshi Song, Sugar Land, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/545,157

(22) Filed: Aug. 21, 2009

Related U.S. Application Data
(60) Provisional application No. 61/229,010, filed on Jul. 28, 2009.

(51) Int. Cl. E21B 17/00; E21B 47/12; H01R 43/00

(52) U.S. Cl. 166/65.1; 29/885

(57) ABSTRACT

Embodiments of the present invention generally relate to a method and apparatus for providing a conductor in a tubular. In one embodiment, a coiled tubing string for use in a wellbore includes: a tubular; a conductor extending at least essentially a length of the tubular; and a tubular coating extending at least essentially the length of the tubular and bonding the conductor to an inner surface of the tubular.

### CROSS-REFERENCE TO RELATED APPLICATIONS

This application claims benefit of U.S. Provisional Application Ser. No. 61/229,010, filed Jul. 28, 2009, which is hereby incorporated by reference in its entirety.

### BACKGROUND OF THE INVENTION

1. Field of the Invention

Embodiments of the present invention generally relate to a method and apparatus for providing a conductor in a tubular.

1. Description of the Related Art

The use of coiled tubing in the oil industry is increasing in popularity for drilling, completion, and production operations in crude oil or natural gas wellbores. Historically, strings of drill pipe were used for drilling and conducting operations inside a wellbore, usually several hundred or thousand feet under the surface of the ground. However, joints of drill pipe must be threaded together and lowered into the wellbore over a long time period of many hours or days. Coiled tubing emerged as a solution by providing a relatively fast and reliable method of conducting operations downhole within a wellbore, without using heavy and cumbersome jointed drill pipe.

Coiled tubing is a continuous tubular strand traditionally made from steel possessing sufficient ductility to withstand flexing as the tubing is uncoiled from a reel for insertion into the wellbore or coiled back onto the reel for removal from the wellbore since the coiled tubing is plastically deformed onto the reel. Coiled tubing is traditionally manufactured by rolling flat strips cut from rolls of sheet steel into a tubular shape and fusion welding the seam. Recent advances include composite coiled tubing strings made from fibers embedded in a resin matrix fibers embedded in a resin matrix. The fibers, usually glass and carbon, are wound around an extruded thermoplastic tube and saturated with a resin, such as epoxy. Another recent advance is seamless steel coiled tubing which may be manufactured by extrusion.

Coiled tubing is deployed using a coiled tubing unit. The coiled tubing unit includes the reel, an injector, controls, and a power pack. The injector feeds the coiled tubing into the wellbore through a stripper mounted on the wellhead. Such a coiled tubing unit is discussed and illustrated in U.S. Pat. No. 5,828,003, which is herein incorporated by reference in its entirety.

Current coiled tubing applications include slim hole drilling, deployment of reeled completions, logging of deviated or highly deviated (i.e., horizontal) wellbores, and deploying treatment fluids downhole. The use of coiled tubing in highly deviated or horizontal wellbores is rapidly increasing at a rapid rate.

Many of these applications would benefit from the ability to transmit and receive data and/or or transmit power from the surface. This ability could be used to monitor the properties of the coiled tubing, detect pressure and temperature inside the wellbore at the distal end and/or along the coiled tubing, monitor and/or control the operation of downhole tools mounted upon the distal end of the coiled tubing, and/or detect an exact depth of the distal end of the coiled tubing.

Past attempts at transmitting data to the surface include wireless telemetry (i.e., mud pulse, electromagnetic, and acoustic). However, wireless telemetry suffers from low bandwidth (i.e., 10 bits/second), latent travel time (speed of sound for acoustic and mud pulse), and inability to transmit electricity. U.S. Pat. No. 6,717,501 to Hall discloses wired drill pipe. However, wired drill pipe suffers from the disadvantages of drill pipe, discussed above. U.S. Pat. No. 6,143,988 to Neuroth discloses a cable disposed in a coiled tubing string. However, Neuroth requires deforming the coiled tubing to support the weight of the cable and a jacket and armor to protect and support the cable. U.S. Pat. No. 5,828,003 to Thomeer discloses coiled tubing made from a composite laminate having conductive wires embedded therein. Thomeer's composite is extremely complicated to design and manufacture. U.S. Pat. No. Re. 36,833 to Moore discloses a continuous tubing having conductors enclosed by a metal strip welded to the tubing as the tubing is roll-formed and welded. U.S. Pat. No. 7,025,580 to Heagy discloses an inflatable liner bonded to a pipe with a resin and having a channel housing a cable conduit.

For some of these applications, it may be desirable to coat an inner surface of the coiled tubing wall to protect the surface from corrosion or plugging. Corrosion may be caused by pumping an acidic solution through the coiled tubing in a formation treatment operation. Plugging may be caused by pumping hydrocarbon fluid through the coiled tubing in a low temperature environment, such as subsea. Byproducts, such as paraffin may condense from the hydrocarbon fluid and adhere to the inner surface of the coiled tubing. Such a coating process is discussed in U.S. patent application Ser. No. 12/388,166 (Atty. Dock. No. TUBE/0003), filed Feb. 18, 2009, which is herein incorporated by reference in its entirety. The '166 application discusses a multi-cycle coating regimen including a degreasing cycle, a rinse cycle, a descaling cycle, a neutralization cycle, a drying cycle, an inhibitor cycle, and a coating cycle. The working fluid for each cycle may be applied using a pig or pigtrain. The protective coating may be a polymer, such as epoxy, polyurethane, or polytetrafluoroethylene (PTFE).

### SUMMARY OF THE INVENTION

Embodiments of the present invention generally relate to a method and apparatus for providing a conductor in a tubular. In one embodiment, a coiled tubing string for use in a wellbore includes: a tubular; a conductor extending at least essentially a length of the tubular; and a tubular coating extending at least essentially the length of the tubular and bonding the conductor to an inner surface of the tubular.

In another embodiment, a tubing string for use in a wellbore includes: a tubular; a first tubular coating extending a length of the tubular and made from an electrically conductive material; and a second tubular coating extending the length of the tubular and made from an electrically insulating material. The first coating is disposed between the second coating and an inner surface of the tubular.

In another embodiment, a method for bonding a conductor to an inner surface of a tubular includes: pumping a volume of coating in front of a pig; and propelling the pig through the tubular, wherein the pig applies the coating to the inner surface having at least a portion of the conductor laid thereon.

In another embodiment, a method for forming a signal conductor along an inner surface of a tubular, includes: pumping a volume of coating in front of a pig; and propelling the pig through the tubular. The pig applies the coating to the inner surface and the coating is electrically conductive.

In another embodiment, a spool pig for use in a coiled tubing string, includes: a nose; a tail; a mandrel connected to the nose and tail; and a spool disposed on the mandrel and rotatable relative to the mandrel.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a spool pig deployed in a coiled tubing string, according to one embodiment of the present invention. FIG. 1A is a detailed view of FIG. 1. FIG. 1B illustrates coating of the inner surface of the coiled tubing. FIGS. 1C and 1D illustrates the conduit bonded to an inner surface of the coiled tubing using the coating. FIG. 1E is a detail of an optical cable disposed in the conduit. FIG. 1F is a detail of an optical fiber disposed in the conduit.

FIG. 2A illustrates coating of the coiled tubing, according to another embodiment of the present invention. FIG. 2B illustrates the optical fiber/cable bonded directly to an inner surface of the coiled tubing using the coating, according to another embodiment of the present invention. FIG. 2C illustrates two fibers laid and bonded to the coiled tubing inner surface.

FIG. 3A illustrates a twisted pair cable bonded to an inner surface of the coiled tubing using the coating, according to another embodiment of the present invention. FIG. 3B illustrates two circumferentially spaced jacketed wires bonded to an inner surface of the coiled tubing using the coating, according to another embodiment of the present invention. FIG. 3C illustrates a coaxial electrical cable bonded to an inner surface of the coiled tubing using the coating, according to another embodiment of the present invention. FIG. 3D illustrates a single electrical wire bonded to an inner coating layer by an outer coating layer, according to another embodiment of the present invention.

FIG. 4A illustrates an electrically conductive layer disposed between two insulating layers, according to another embodiment of the present invention. FIG. 4B illustrates two electrically conductive layers each disposed between two insulating layers, according to another embodiment of the present invention. FIG. 4C illustrates an electrically conductive layer disposed between two insulating layers and having a jacketed wire bonded to an inner surface of the coiled tubing, according to another embodiment of the present invention.

FIG. 5A is a cross section of a male coupling installed at a first end of the coiled tubing, according to another embodiment of the present invention. FIG. 5B is a cross section of a female coupling installed at a second end of the coiled tubing. FIG. 5C is a cross section of connected male and female couplings.

FIGS. 6A-6F illustrate a method for splicing one of the couplings 500f,m to one of the coiled tubing ends 55, according to another embodiment of the present invention.

### DETAILED DESCRIPTION

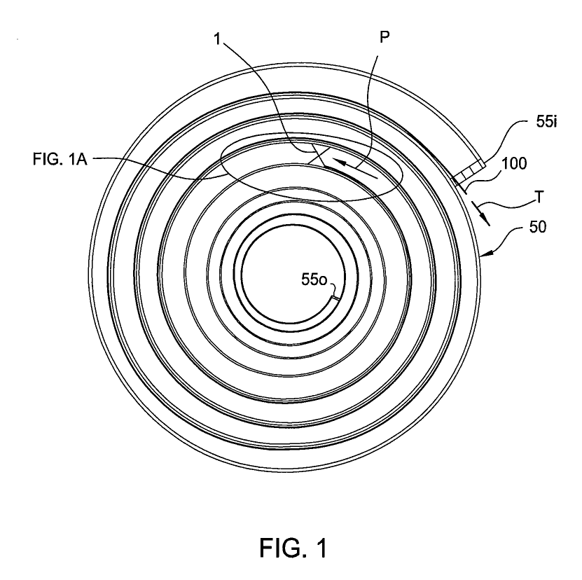

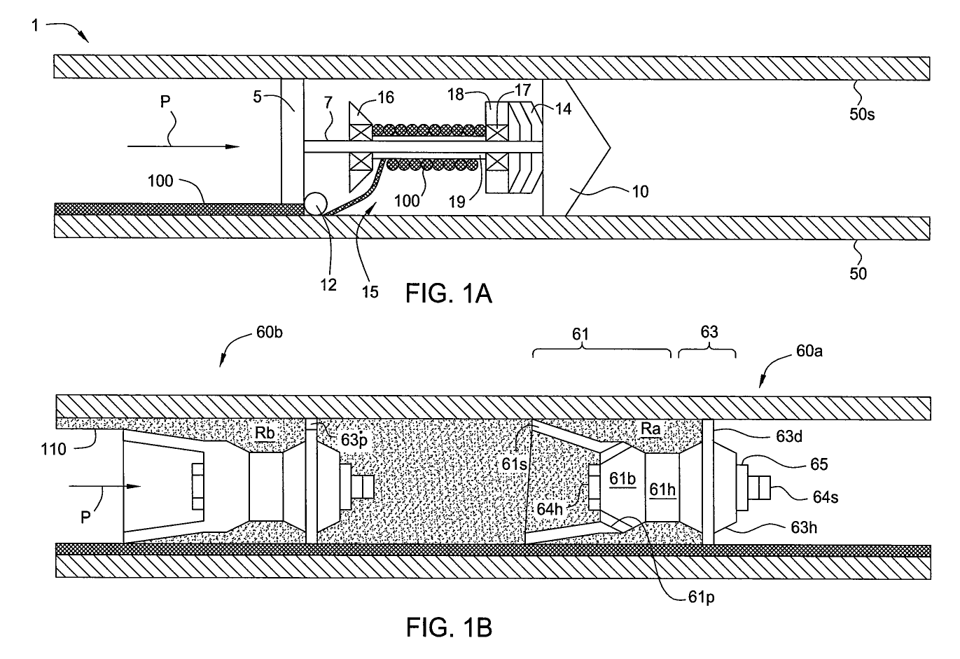

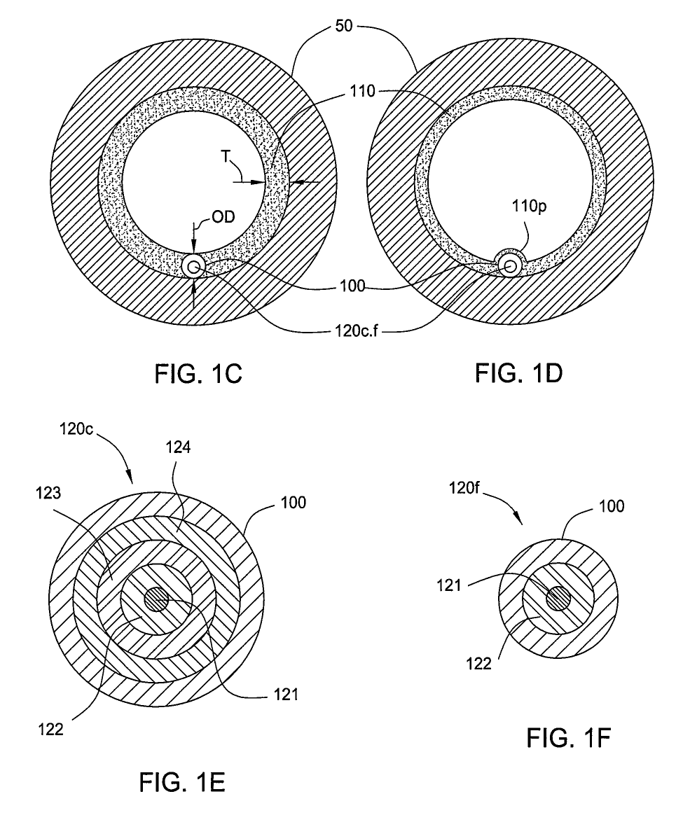

FIG. 1 illustrates a spool pig 1 deployed in a coiled tubing string 50, according to one embodiment of the present invention. Alternatively, the spool pig 1 may be deployed in other tubular strings, such as a pipeline, reeled pipe, drill pipe, production tubing, or casing. The coiled tubing string 50 may be made from a metal or alloy, such as plain carbon steel, low alloy steel, or a corrosion resistant alloy, such as QT-16Cr, HS-80, titanium, or stainless steel. Alternatively, the coiled tubing string may be made from a composite, such as a fiber (i.e., glass or carbon) reinforced polymer resin (i.e., epoxy or PVC). The coiled tubing 50 may have a length of greater than or equal to one thousand, five thousand, ten thousand, twenty thousand, or thirty thousand feet. The coiled tubing 50 may have an outer diameter ranging from three-quarters of an inch to four inches and have a wall thickness ranging from 0.08 to one-quarter of an inch.

In preparing the coiled tubing 50 for deployment of the spool pig 1, an inlet 55i and outlet 55o of the tubing 50 may be located at or near ground level to allow for easier access. A clamp (not shown) may be secured to each of the inlet 50i and outlet 50o. Each clamp may have a flange to receive corresponding flanges of a pig launcher (not shown) and a pig receiver (not shown). A suitable pig launcher and receiver are illustrated in FIGS. 1 and 9-11 of U.S. Pat. No. 5,230,842, which is herein incorporated by reference in its entirety. As discussed above and in the '166 application, an inner surface 50s of the coiled tubing 50 may be treated to remove manufacturing or other debris until a white-metal or near white-metal finish, such as NACE number one or two, is achieved.

To deploy the spool pig 1 into the coiled tubing 50, the spool pig may be loaded into the launcher. Alternatively, the spool pig 1 may be launched into the coiled tubing string without using a launcher and/or receiver. Propellant P may be injected into the launcher to drive the spool pig 1 through the coiled tubing 50. The propellant P may be a fluid, such as liquid or compressed gas, such as ambient air, dry air, or nitrogen. As the spool pig 1 travels through the coiled tubing 50, a conduit 100 may unwind from the spool pig 1. An end of the conduit distal from the spool pig 1 may be fastened to the inlet or the launcher. The spool pig 1 may exert tension T on the conduit 100 as the spool pig 1 travels through the coiled tubing, thereby retaining the coiled tubing along an inner curvature of the coil. When the spool pig 1 reaches the outlet 55o, the spool pig 1 may be caught by the receiver and removed from the coiled tubing string 50. A proximate end of the conduit 100 may be fastened to the receiver, outlet, or a tensioner (not shown). The conduit 100 may be made from a metal or alloy, such as steel or aluminum, or a polymer, such as polyvinyl chloride (PVC).

FIG. 1A is a detailed view of FIG. 1. The spool pig 1 may include tail 5, a mandrel 7, a nose 10, a guide 12, a tensionser 14, and a spool 15. The spool 15 may include a rear rim 16, one or more bearings 17, a front rim 18, and a sleeve 19. The mandrel 7 may be a rod having threaded ends and made from a metal or alloy, such as steel, or a polymer. Alternatively, the mandrel 7 may be a tubular capped at each longitudinal end thereof. The nose 5 and tail 10 may each be seals and may be retained on the mandrel 7 using fasteners (not shown) or may include a hub portion having a threaded inner surface and a disc/cone portion. The seals (or disc/cone portions thereof) 5, 10 may each be made from a polymer, such as polyurethane, ploychloroprene, or polyisoprene and the hub portion may be made from a metal or alloy, such as steel. The front seal 10 may be conical for guiding the pig through the coiled tubing 50.

The guide 12 may be a roller mounted to the mandrel 7 or rear rim 16 for feeding the conduit 100 from the spool 15 to the coiled tubing inner surface 50s. The tail 5 may have a notch formed in an outer surface thereof for passage of the conduit 100. The conduit 100 may be wrapped along the sleeve 19 and retained by the rims 16, 18. The bearings 17 may each be disposed between the head 18 or tail 16 and the mandrel 7. Alternatively, the bearings 17 may be disposed between the sleeve 19 and the mandrel 7. The bearings 17 may longitudinally connect the spool 15 to the mandrel 7 while allowing relative rotation therebetween. The bearings 17 may be fastened to the mandrel 7 and the spool 15. The tensioner 14 may include one or more Beliville washers engaging the front rim 18 and the nose 10 to frictionally dampen rotation of the spool 15, thereby maintaining tension T in the conduit. The rims 16, 18 and sleeve 19 may be integrally formed or fastened together, such as by threaded connections.

Alternatively, instead of a spool pig 1, the spool of conduit 100 may be located externally of the coiled tubing 50 and a simple pig may be used to pull the distal end of the conduit through the coiled tubing 50.

FIG. 1B illustrates coating of the inner surface 50s of the coiled tubing 50. An interior coating may be applied to the inner surface 50s of the tubing 50, having the conduit 100 laid thereon, while the tubing 50 is in place on the reel, using extruder pigs 60a,b. A first or lead extruder pig 60a and a second or trail extruder pig 60b may be inserted into a loading chamber of the pig launcher in a spaced relationship, with fluid ports of the chamber positioned between the loaded pigs 60a,b. A predetermined volume of the fluid coating 110 may be injected, such as pumped, into the space between the loaded pigs and the air between the pigs may be vented. After the fluid coating has been injected, propellant may be injected behind the trail pig, thereby driving the pigtrain through the coiled tubing 50. A pressure of the propellant may be selected to control velocity of the pigtrain and coating thickness.

The lead extruder pig 60a may include a cup 61, a seal 63, and one or more fasteners 64h,s, 65. The cup 61 may include a wiper 61b,s and a hub 61h. The wiper 61b,s may be molded to the hub 61h. The seal 63 may include a disc 63d and one or more hubs 63h. The disc 63d may be molded between the two hubs 63h. The wiper 61b,s, and disc 63d may each be made from a polymer, such as polyurethane, ploychloroprene, or polyisoprene and the hubs 61h, 63h may be made from a metal or alloy, such as steel. The hubs 61h, 63h may be connected by a longitudinally extending fastener, such as a bolt 64h,s and a nut 65 engaged with a threaded shank 64s of the bolt. A head 64h of the bolt may shoulder against a base 61b of the wiper 61b,s.

An outer portion of the disc 63d may be in sealing engagement with the coiled tubing inner surface 50s and be solid. The wiper 61b,s may have a flexible, cylindrical wall or skirt 61s, extending rearwardly from a base 61b connected or mounted to the bolt 64h,s. The flexible skirt 61s may be expandable outwardly in response to pressure differential during movement of the pig 60a through the coiled tubing 50 in coating operations. When so expanded outwardly, the skirt 61s may define an annular front reservoir Ra between the disc 63d and the skirt 61s. The skirt 61s and the outer portion of the disc 63d may be flexible enough to accommodate passage over the conduit 100. Alternatively, the skirt and the disc may each have a notch formed in an outer portion thereof and aligned with the conduit to accommodate the conduit. The annular reservoir Ra may be filled with a volume of the coating material 110 to be applied to the interior surface of the coiled tubing 50. The coating material 110 in reservoir Ra may be urged toward the coiled tubing inner surface under the force of the pressure moving the lead pig 60a through the tubing 50, and the flared skirt 61s may exert a wiping blade action about its outer periphery for this purpose. One or more feed ports 61p may be formed through the base 61b. The feed ports 61p may allow passage into the annular reservoir R of the coating material 110 from a main charge of coating material 110 transported between the pigs 60a,b.

The trail pig 60b may be similar to the lead pig 60a except that the disc 63d may have one or more passages or slots 63p formed through an outer portion thereof and the ports 61p may be omitted. The size and number of coating material slots 63p may be chosen to regulate the amount of coating material 110 which may pass rearwardly of the disc 63d into a rear reservoir Rb. One of the ports 63p may or may not be sized and aligned with the conduit 100 to accommodate the conduit 100. The rear reservoir Rb may receive a regulated volume of coating material 110 from the main charge through the slots 63p as the trail pig 60b moves through the coiled tubing 50. The skirt 61s of the trail pig 60b may be flexible outwardly to a position where an outer rim is spaced from the coiled tubing inner surface 50s to define a circumferential gap. As with the skirt 61s of the lead pig 60a, the skirt 61s of the trail pig 60b may be flexible enough to accommodate passage over the conduit 100 or may have a notch formed in an outer portion thereof in alignment with the conduit to accommodate the conduit. The amount of flexure of rear pig skirt 61s and thus the size of the gap may be governed by the propellant pressure selected for movement of the pigs 60a,b through the coiled tubing 50. The selected pressure, in conjunction with the regulated volume of coating material 110 in reservoir Rb, may be used to regulate the thickness of coating material 110 deposited on the coiled tubing inner surface 50s.

An initial volume of the main charge may be sufficient to coat a length of the coiled tubing inner surface 50s with a coating 110 of predetermined thickness. After the leading and trailing extruder pigs 60a,b have been driven through the coiled tubing 50 to the receiver, the coating layer 110 may be dried by passing a sufficient volume of dehydrated air through the tubing for a time sufficient to thoroughly dry the coating layer 110. Depending on the specific coating material selected, the coating layer may require an additional curing step after it has been completely dried. For instance, where PTFE is used as the coating material, the tubing may be heated by unwinding the coiled tubing from the reel, through an oven, and then back onto a second storage reel.

As discussed more below, it may be desirable to apply one or more additional layers of the coating, whether of the same or different coating material. After the first coating layer has been dried with dehydrated air, the extruder pigs 60a,b, together with another quantity of coating material therebetween, may be loaded in reverse order and position into the downstream tubing section along with a new mass or charge of coating material to apply a second layer of coating. Alternatively, the extruder pigs 60a,b may be removed and loaded in the same order and position at the upstream loading chamber in the manner described above. The drying and/or curing process may then be repeated. Alternatively, the lead extruder pig 60a may be omitted and only the trail pig 60b may be used to apply the coating 110.

FIGS. 1C and 1D illustrates the conduit 100 bonded to an inner surface 50s of the coiled tubing 50 using the coating 110. Once dried and/or cured, the coating 110 forms a tubular lining bonded to the inner surface 50s and extending the length of the coiled tubing 50. A thickness T of the coating 110 may be equal or substantially equal to an outer diameter OD of the conduit 100 so that the conduit is flush or substantially flush with an inner surface of the coating. Alternatively, the coating thickness T may be less than or substantially less than the conduit outer diameter OD, such as less than three-quarters, one-half, one quarter, one-eighth, or one-sixteenth the outer diameter OD. A portion or substantial portion of the conduit outer surface may still be covered by a protrusion 110p of the coating or the conduit portion may be exposed to a bore of the coiled tubing. The coating thickness T may be from a single layer of the coating or an aggregate thickness resulting from two or more layers of the coating. Each layer of coating may have a thickness ranging from 0.0005 to 0.05 of an inch and an aggregate thickness of the coating may range from 0.001 to one-quarter of an inch.

In addition to bonding the conduit 100 to the inner surface 50s, the coating 110 may serve to protect the inner surface 50s from corrosion, erosion, and/or plugging. The coating 110 may be made from a polymer, such as epoxy, polyurethane, or PTFE or, as discussed below, a composite, such as a metal/alloy-filled polymer. The coating 110 may be electrically insulating or electrically conductive.

FIG. 1E is a detail of an optical cable 120c disposed in the conduit 100. FIG. 1F is a detail of an optical fiber 120f disposed in the conduit 100. The optical cable may include a core 121, a cladding 122, a buffer 123, and a jacket 124. The core 121 and cladding 122 may be made from a ceramic, such as silica. The buffer 123 and jacket 124 may be made from a polymer. The fiber 120f may include only the core 121 and the cladding 122. The optical cable 120c may include a plurality of fibers. The cable/fiber 120c,f may be inserted into the conduit 100 before or after the conduit 100 is boned to the coiled tubing inner surface 50s by the coating 110. The cable/fiber 120c,f may be inserted into the conduit 100 by gravity deployment or pumping using air or fluid. Disposing the cable/fiber 120c,f in a conduit 100 may reduce stress exerted on the fiber/cable by changes in stress of the coiled tubing 50, such as by unwinding/winding of the coiled tubing on the reel, exerting loads on the coiled tubing in the wellbore, or thermal expansion of the coiled tubing due to deployment in the wellbore. The stress reduction may occur because the conduit 100 is bonded to the coiled tubing 50 and the cable/fiber 120c,f may move relative to the coiled tubing, thereby providing a strain buffer for the cable/fiber.

Once the conduit 100 is bonded to the coiled tubing inner surface 50s and the fiber/cable 120f,c is inserted through the conduit, the coiled tubing may be deployed into a wellbore, such as for a drilling operation. A BHA (not shown) including a drill bit, a mud motor, a bent sub, an orienter, and a sensor sub (i.e., MWD and/or LWD) may be connected to a distal end of the coiled tubing. The cable/conduit may be used to transmit data from the BHA to the surface, such as temperature, pressure, drill bit orientation, torque, and rotary speed of the bit. The data may be transmitted at high rates, such as one or more kilo-bits, mega-bits, or giga-bits per second. The data may also be transmitted in real time (no latency time). Additionally, the sensor sub may include logging sensors to detect formation characteristics while drilling. Communication may be bidirectional such that data is sent from the BHA to the surface and instructions may be sent from the surface to the BHA, such as to actuate the orienter. Additionally, optical power may be transmitted from the surface along the fiber/cable 120f,c to an additional generator sub of the BHA including one or more photovoltaic cells. The power and data may be multiplexed on a single cable/fiber or a second cable/fiber may be added for power. The generator may used to power one or more components of the BHA, such as the orienter and/or sensor sub.

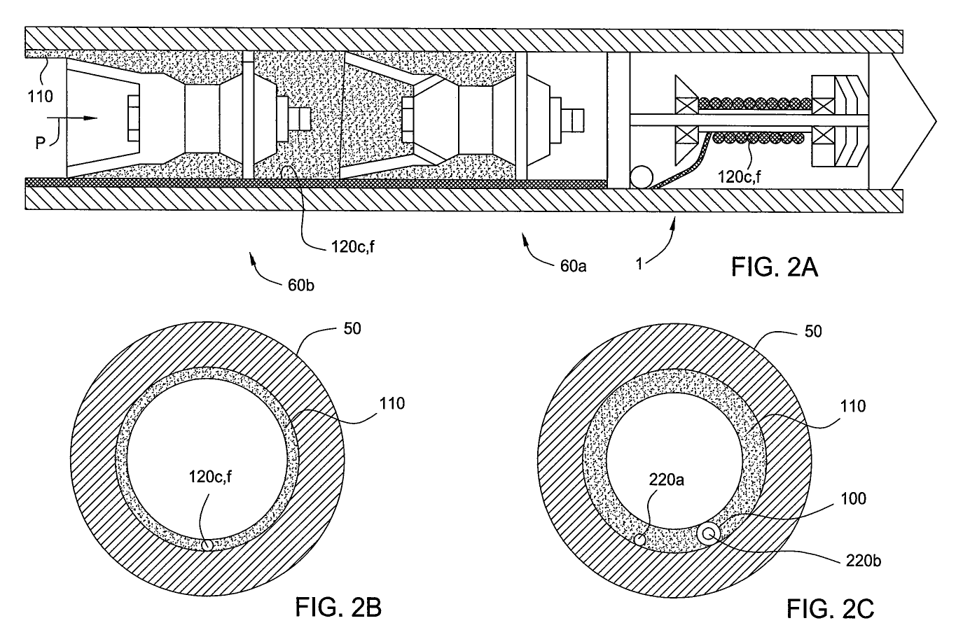

FIG. 2A illustrates coating of the coiled tubing 50, according to another embodiment of the present invention. Instead of deploying the spool pig 1 and then deploying the extruder pigs 60a,b in separate steps, the spool pig and extruder pigs may be deployed simultaneously in a single pigtrain. The cable/fiber 120c,f may also be bonded directly to the coiled tubing inner surface 50s without the conduit 100. Alternatively, the conduit 100 may be deployed. Alternatively, the cable/fiber 120c,f may be laid and bonded directly to the coiled tubing inner surface 50s using separate steps. As the cable/fiber 120c,f is laid from the spool pig 1, the extruder pigs 60a,b may immediately follow by applying the coating 110. Alternatively, the lead extruder pig 60a may be omitted. Omitting the conduit 100 may allow for a thinner coat 110 to be applied. Alternatively, the cable/fiber 120c,f may be laid in a helical path along the inner surface 50s to act as a strain buffer between the cable/fiber 120c,f and the coiled tubing 50.

FIG. 2B illustrates the optical fiber/cable 120f,c bonded directly to the coiled tubing inner surface 50s using the coating 110, according to another embodiment of the present invention. When bonding the fiber directly (no conduit) to the inner surface of the coiled tubing, a thickness T of the coating 110 may be greater or substantially greater than an outer diameter OD of the fiber 100 so that the fiber is sub-flush or substantially sub-flush with an inner surface of the coating. The coating may be applied in multiple layers to accomplish the sub-flush relationship, i.e. the fiber is bonded with a first coating layer and then a second coating layer completely embeds the fiber. When bonding the optical cable directly to the inner surface of the coiled tubing, the coating thickness may be less than, equal to, or greater than the cable outer diameter OD.

FIG. 2C illustrates two fibers laid and bonded to the coiled tubing inner surface 50s. A first cable/fiber 220a may be directly bonded to the surface 50s and a conduit 100 may be bonded housing a second cable/fiber 220b. The fibers 220a,b may be used as a longitudinal strain gage for the coiled tubing 50 disposed in and/or being injected into a wellbore. The first fiber 220a may experience temperature and strain of the coiled tubing and the second fiber 220b may experience temperature of the coiled tubing. The second fiber 220b may be used to compensate the first fiber strain measurement for temperature. Using the longitudinal strain gage 220a,b, stress along the coiled tubing may be monitored and recorded to more accurately determine fatigue life of the coiled tubing. The neutral point of the coiled tubing may be determined during drilling applications so that the coiled tubing may be kept in tension during drilling for longer life expectancy. Weight on bit may be communicated to an automated injector controller so that the controller may maintain a predetermined weight-on-bit while injecting the coiled tubing into the wellbore during a drilling operation. For example, during a directional drilling operation, the predetermined WOB may equal or exceed a first order buckling threshold but be less than or substantially less than a second order buckling threshold to prevent damage to the coiled tubing. Further, as discussed above, the controller may receive torque and pressure measurements from the BHA. The controller may also receive pressure measurements from the rig pump. With all of the data, the controller may calculate a resultant stress state along the coiled tubing 50 and optimize drilling conditions from the calculated resultant stress state. For example, the controller may prevent overload of a local portion of the coiled tubing.

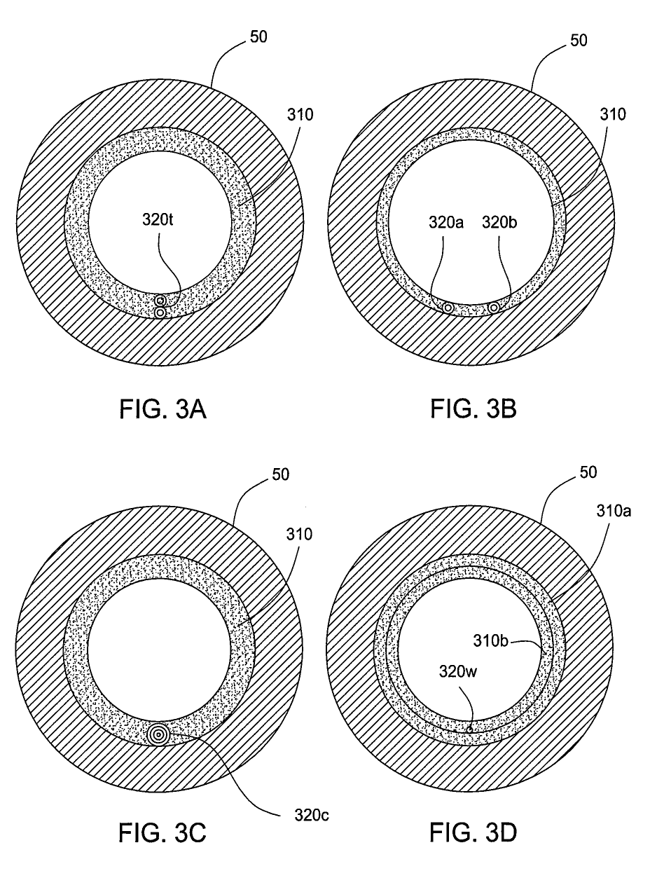

FIG. 3A illustrates a twisted pair cable 320t bonded to the coiled tubing inner surface 50s using the coating 110, according to another embodiment of the present invention. The twisted pair cable 320t may include two wires made from an electrically conductive metal or alloy, such as aluminum, copper, or alloys thereof, each wire jacketed with a dielectric material, such as a polymer. The wires and jackets may be helically intertwined and the jackets bonded to form the cable. The cable 320t may be directly bonded to the inner surface as shown or inserted into the conduit 100.

Alternatively, a single jacketed wire may be used instead of the twisted pair. In this alternative, an earth return circuit may be use to conduct data signals or electricity between the surface and the BHA. Additionally, an optical cable/fiber may be bonded to the inner surface by the coating so that the twisted pair cable may be used to transmit electricity and the optical fiber/cable may be used to transmit data. The additional optical cable/fiber may be circumferentially spaced from the twisted pair/cable and bonded directly to the inner surface or be disposed in the conduit with the cable for the conduit alternative discussed above.

FIG. 3B illustrates two circumferentially spaced jacketed wires 320a,b bonded to an inner surface of the coiled tubing 50 using the coating 110, according to another embodiment of the present invention. The wires 320a,b may be directly bonded to the coiled tubing inner surface. Additionally, an optical fiber/cable may be bonded to the inner surface and circumferentially spaced from the wires 320a,b.

FIG. 3C illustrates a coaxial electrical cable 320c bonded to an inner surface of the coiled tubing 50 using the coating 110, according to another embodiment of the present invention. The coaxial cable may include a core, a buffer, a shield, and a jacket. The core and the shield may be made from an electrically conductive material. The buffer and the shield may be made from a dielectric. The shield may be a braid, tube, foil, or combinations thereof.

FIG. 3D illustrates a single electrical wire 320w bonded to an outer coating layer 310a by an inner coating layer 310b, according to another embodiment of the present invention. The inner coating layer 310b may insulate the bare wire 320w from the coiled tubing inner surface 50s and the outer coating layer 310b may insulate the bare wire 320w from fluid conducted through the coiled tubing bore. The thickness of the outer coating layer 310b may be greater or substantially greater than a diameter of the wire 320w. As discussed above, the inner 310b and/or outer 310a coating layer may be an aggregate of several layers. Additionally, a second bare wire may be circumferentially spaced from the wire 320w. Alternatively, the bare wire may be inserted into the conduit and the outer layer 310a may be omitted. If the tubing 50 is made from the composite material, the outer layer 310a may be omitted and the bare wire 320w may be bonded directly to the tubing 50.

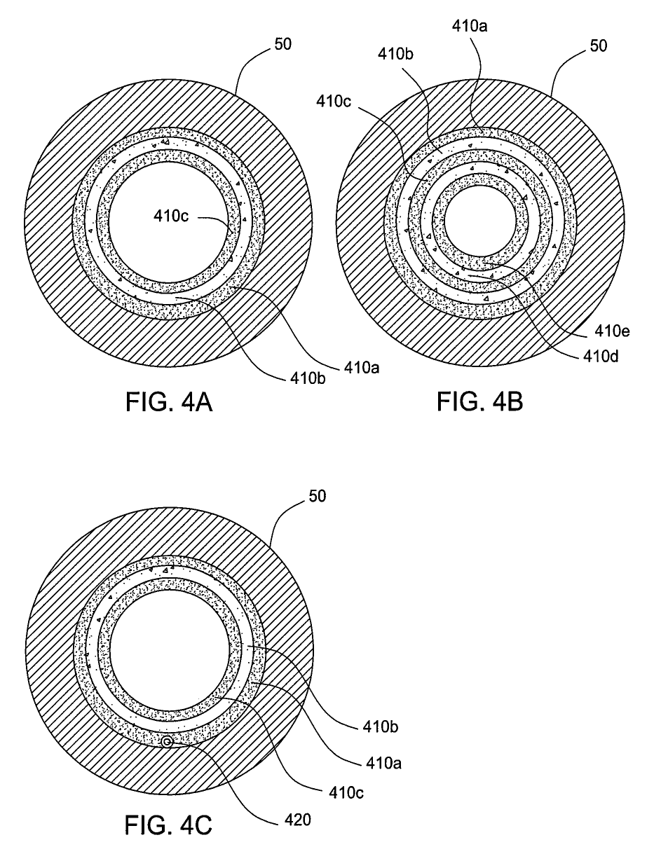

FIG. 4A illustrates an electrically conductive layer 410b disposed between two insulating layers 410a,c, according to another embodiment of the present invention. The electrically conductive layer 410b may be made from a composite, such as a metal/alloy (i.e., copper, aluminum, gold, platinum, or silver) filled polymer resin or carbon-filled polymer resin. The filling may be non-spherical or irregular particles or nano-particles, such as grains, fibers, or tubes. The metal or alloy may be plated on another metal or alloy (i.e. silver plated nickel) or coated on glass beads to reduce cost. The polymer resin may be filled past the percolation threshold. The insulating layers 410a,c may electrically isolate the conductive layer 410b from the coiled tubing inner surface 50s and fluid in the coiled tubing bore. The conductive layer 410b may conduct signals and/or electricity using an earth return circuit. The thickness of the conductive layer 410b may be selected to provide the same resistivity as standard copper wire for data and/or electrical transmission, such as 22 AWG copper wire. If the coiled tubing 50 is made from the composite material, the outer layer 410a may be omitted.

The conductive layer 410b may further be used to monitor the integrity of one or both of the insulating layers 410a,c. For example if the inner insulating layer 410c is compromised by fluid erosion, a short may form between the conductive layer 410b and fluid in the coiled tubing bore, thereby substantially altering resistance of the conductive layer. The failure may be detected and the coiled tubing 50 retrieved to the surface for repair or replacement.

FIG. 4B illustrates two electrically conductive layers 410b,d each disposed between two insulating layers 410a,c,e, according to another embodiment of the present invention. The two conductive layers 410b,d may provide a complete circuit through the coiled tubing 50 without using earth for the return circuit.

FIG. 4C illustrates an electrically conductive layer 410b disposed between two insulating layers 410a,c and having a jacketed wire 420 bonded to an inner surface of the coiled tubing 50, according to another embodiment of the present invention. Including the jacketed wire 420 makes dual use of the insulating layer 410a. The insulating layer 410a may isolate the conductive layer 410b and bond the wire 420 to the inner surface. Alternatively, the jacketed wire 420 may be disposed in the conduit 100. If the coiled tubing 50 is made from the composite material, the wire 420 may be bare. Additionally or alternatively, the optical cable/fiber may be disposed in the outer layer 410a.

The coiled tubing string 50 having any of the conductors 120,320,410b,d, 420 may be used to charge a battery of a downhole tool installed in the wellbore. A coupling may be connected to a distal end of the coiled tubing 50. The coiled tubing 50 may then be injected into the wellbore until the coupling engages or is proximate to the downhole tool. The coupling may be wired or wireless (i.e., inductive coupling). Electricity may be transmitted from the surface to the downhole tool, thereby charging the battery of the downhole tool. The coiled tubing may then be retrieved to surface. Any of the conductors 120, 320, 410b,d, 420 may be used to power any downhole tool, such as a sensor sub, an orienter, a motor, and/or a tool actuator, such as a valve actuator.

Alternatively, the coiled tubing 50 may be used as production tubing, and any of the conductors 120,320,410,420 may be used to transmit data and/or power between temperature and pressure sensors of a sensor sub connected to a distal end of the coiled tubing and the surface. Alternatively, the conductors 120,320,410,420 may be bonded to an inner surface of a production tubing string instead of a coiled tubing string.

Alternatively, any of the conductors 120,320,410,420 may be used to heat the coiled tubing 50, such as for melting/disassociating a paraffin or gas hydrates plug or preventing the formation thereof.

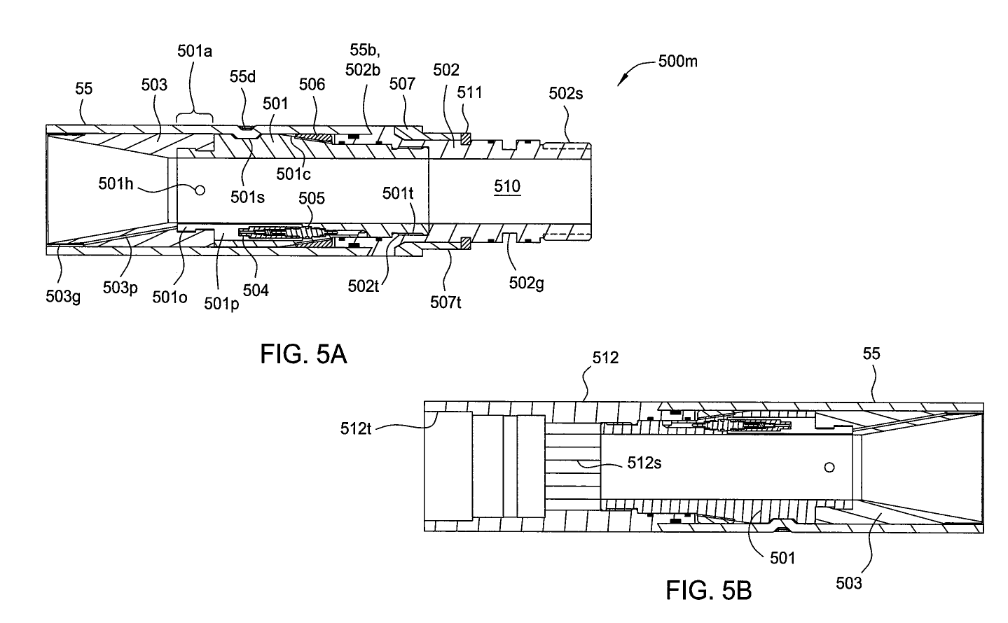

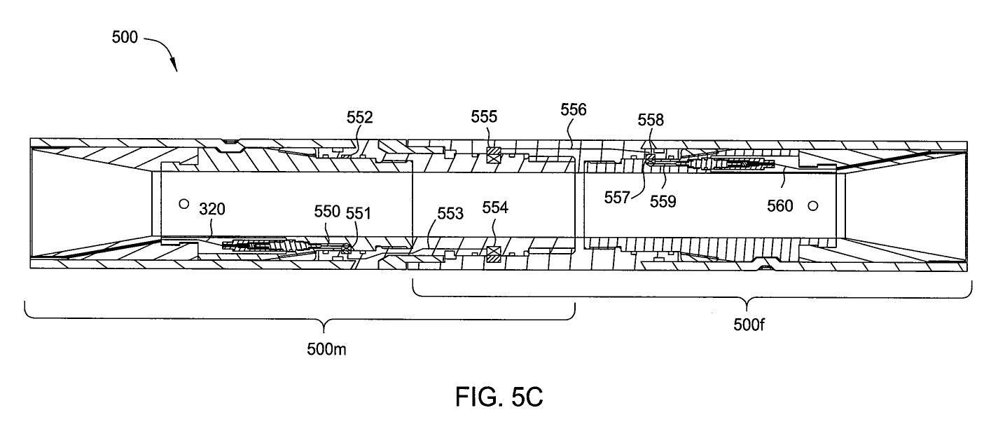

FIG. 5A is a cross section of a male coupling 500m installed at a first end 55 of the coiled tubing 50, according to another embodiment of the present invention. The male coupling 500m may include a mandrel 501, a pin 502, and a diverter 503. The mandrel 501 and the pin 502 may be made from any of the coiled tubing materials, discussed above. The diverter 503 may be made from a polymer, such as polyurethane, ploychloroprene, polyisoprene, or any elastomer.

The diverter 503 may have a conical inner surface for transitioning flow from a bore of the coiled tubing to a bore 510 of the coupling 550m. A profile 501a may be formed in an end of the mandrel 501 for receiving the diverter 503. The profile 501a may include a shoulder and a lip. The shoulder may abut an end of the diverter and the lip may have an outer diameter slightly larger than an inner diameter of a corresponding profile of the diverter, thereby forming an interference fit and longitudinally and torsionally connecting the diverter 503 and the mandrel 501. Additionally or alternatively, an adhesive (not shown) may be used to bond the diverter 503 to the mandrel 501. Each of the diverter 503 and the mandrel 501 may have a hole 501h (only mandrel hole shown) formed therethrough for pressure equalization. A groove 503g may be formed in an outer surface of the diverter 503 for receiving an end of the coating 310. A port 503p may be formed in a wall of the diverter 503 and in communication with the groove 503g for passage of one of the conductors 320. A portion of the groove 503g adjacent the port may be enlarged for receiving one of the conductors 320.

An opening 501o may be formed in an outer surface of the profile 501a and a port 501p may be formed in a wall of the mandrel 501. The opening 501o may provide for passage of one of the conductors 320 and the port 501p may house a booted contact 504 and high pressure feed-thru 505. An end of the conductor 320 may be sealed within the booted contact 504 and the booted contact may provide electrical communication between the conductor 320 and the feed-thru 505 via connection with a first end of the feed-thru. A second end of the feed-thru may be in electrical communication with a lead 550 (FIG. 5C). A recess 501r may be formed in the mandrel outer surface for receiving a spring contact 551 (FIG. 5C). The spring contact 551 may be connected to the lead 550 and may abut a contact ring 552 (FIG. 5C) disposed in an inner surface of the pin 502. The contact ring 552 may be connected to a lead 553 (FIG. 5C) extending through a wall of the pin 502 to a groove 502g formed in an outer surface of the pin. A spring ring contact 554 (FIG. 5C) may be disposed in the groove 502g for providing electrical communication between the pin 502 and a box 512 of the female coupling 500f.

The mandrel 501 may have a socket 501s formed in an outer surface thereof and the coiled tubing end 55 may have a dimple protruding from an inner surface thereof received by the socket, thereby longitudinally and torsionally connecting the mandrel to the coiled tubing end. The connection may be reinforced in tension by a conical outer surface 501c of the mandrel 501 receiving a split wedge ring 506 and abutment of the wedge ring 506 with an inner surface of the coiled tubing end 55. The mandrel 501 may also have a threaded outer surface 501t engaging a threaded inner surface 502t of the pin 502, thereby longitudinally and torsionally coupling the pin and the mandrel. A nut 507 may be longitudinally connected to the pin 502 by a shoulder and a fastener, such as a snap ring 511. The nut 507 may rotate freely relative to the pin 502. The nut 507 may have a threaded outer surface 507t. The pin 502 may have splines 502s formed around an outer surface thereof and at a tip thereof. A tip of the coiled tubing end 55 and a shoulder of the pin 502 may each be beveled 55b, 502b so a smooth and flush aggregate outer surface is formed. Various interfaces of the coupling 500m may be sealed with seals (denoted by black filling), such as o-rings.

FIG. 5B is a cross section of a female coupling 500f installed at a second end 55 of the coiled tubing 50. The male coupling 500m may be installed at the external end 55i and the female coupling may be installed at the internal end 55o of the coiled tubing 50 or vice versa. Alternatively, both ends 55 may include male 500m or female 500f couplings. The female coupling 500f may include the mandrel 501, a box 512, and the diverter 503. As with the male coupling 500m, the box 512 may be fastened to the mandrel 501 with a threaded connection. As with the pin 502, the mandrel spring contact 557 (FIG. 5C) may abut a contact ring 558 (FIG. 5C) disposed in an inner surface of the box 512. The contact ring 558 may be connected to a lead 556 (FIG. 5C) extending through a wall of the box 512 to a contact band 555 disposed on an inner surface of the box 512. The contact band 555 may receive the pin spring ring contact 554, thereby electrically connecting the pin 502 and the box 512. An inner surface of the box 512 adjacent a tip of the mandrel 501 may have splines 512s formed therein for receiving the splined tip 502s of the pin 502, thereby torsionally connecting the pin and the box. An inner surface of the box 512 proximate a tip of the box may be threaded 512t for receiving the nut 507, thereby longitudinally connecting the pin 502 and the box 512.

FIG. 5C is a cross section of a connected coupling assembly 500. Assuming the male coupling 500m is connected to the coiled tubing end 55 and the female coupling 500f is connected to a tool (not shown), such as a BHA or injector, a conductor 560 of the tool may extend through the diverter 503 and be sealed within the booted contact 504 connected to the feed-thru 505. A lead 559 may extend from the feed-thru 505 to the mandrel spring contact 557, thereby providing electrical communication between the tool and the conductor 320.

Additionally, the male 500m and female 500f couplings may include a second booted contact 504, feed-thru 505, and leads/contacts 550-559 so that a second conductor (i.e., twisted pair 320t, circumferentially spaced 320b, or coax 320t) may be used.

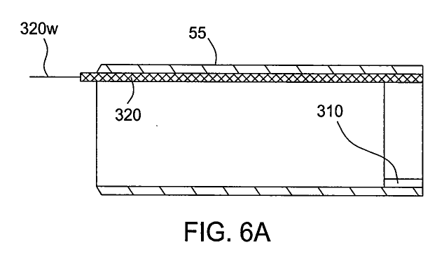

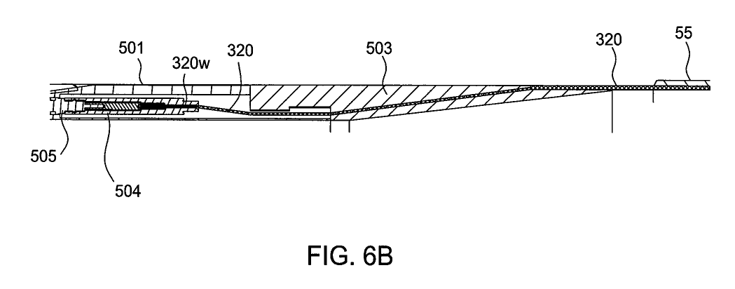

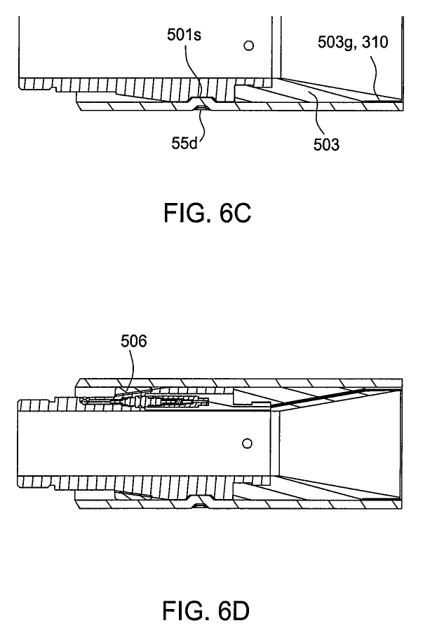

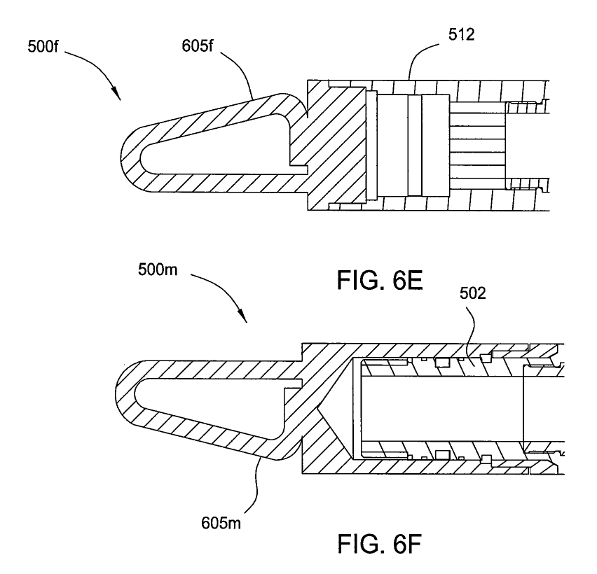

FIGS. 6A-6F illustrate a method for splicing one of the couplings 500f,m to one of the coiled tubing ends 55, according to another embodiment of the present invention. Once the conductor 320 has been bonded to the coiled tubing 50 with the coating 310, a portion of the coating 310 may be cut and removed from the coiled tubing end 55, thereby allowing reception of the coupling 500f,m. A portion of the jacket may then be stripped from the conductor 320 to expose the wire 320w. Additionally, if the conduit 100 is used, a portion of the conduit may also be stripped from the conductor 320. The conductor 320 may then be inserted through the diverter passage 503p. Alternatively, the jacket may be stripped after insertion through the diverter passage. The exposed wire 320w may then be sealed in the booted contact 504. The booted contact 504 may then be fastened to the feed-thru 505. The diverter 503 may then be connected to the mandrel 501. The mandrel 501 and the diverter 503 may then be inserted into the coiled tubing end 55 until an end of the coating 310 is received into the groove 503g. The coiled tubing end 55 may then be crimped, thereby forming the dimple 55d into the socket 501s. The split wedge ring 506 may then be pressed into the coiled tubing end 55. To protect the couplings 500f,m during shipment and storage and to allow handing of the coiled tubing ends 55, a protector and lift plug/cap 605f,m may be fastened to each of the couplings 500f,m, such as with a threaded connection.

Once spooled on a reel of the coiled tubing unit, the coupling at the internal end 55i may be connected to a hydraulic or mud system and a data and/or power system using one or more swivels (not shown), such as an electrical and/or hydraulic swivel or an optical and/or hydraulic swivel. The electrical swivel may include slip rings or inductive couplings to transfer data and/or power.

Additionally, either of the couplings 500f,m may be used to connect the coiled tubing string 50 to a second coiled tubing sting (not shown) having either or both the couplings 500f,m to create a longer string, such as for insertion into deep wellbores.

While the foregoing is directed to embodiments of the present invention, other and further embodiments of the invention may be devised without departing from the basic scope thereof, and the scope thereof is determined by the claims that follow.

1. A tubing string for use in a wellbore, comprising:
a tubular;
a conductor at least essentially extending a length of the tubular; and
a tubular coating at least essentially extending the length of the tubular and bonding the conductor to an inner surface of the tubular.

2. The tubing string of claim 1, wherein the conductor comprises an optical fiber or electrically conductive wire and a conduit housing the fiber or the wire.

3. The tubing string of claim 2, wherein the conduit houses the optical fiber.

4. The tubing string of claim 3, wherein the fiber is part of an optical cable.

5. The tubing string of claim 3, further comprising a second optical fiber bonded directly to the inner surface by the coating.

6. The tubing string of claim 2, wherein a thickness of the coating is substantially equal to or less than an outer diameter of the conduit.

7. The tubing string of claim 2, wherein the conduit houses the wire.

8. The tubing string of claim 7, wherein the wire is part of a twisted pair of jacketed wires.

9. The tubing string of claim 7, wherein the wire is part of a coaxial cable.

10. The tubing string of claim 1, wherein the conductor comprises an optical or electrical cable bonded directly to the inner surface.

11. The tubing string of claim 1, wherein the conductor comprises an optical fiber or electrically conductive jacketed wire bonded directly to the inner surface.

12. The tubing string of claim 1, wherein:
the coating is made from an electrically insulating material,
the conductor comprises a bare electrically conductive wire, and
the tubing string further comprises a second tubular coating at least essentially extending the length of the tubular and made from an electrically insulating material,
wherein the coating isolates the wire from the inner surface and the second coating isolates the wire from a bore of the tubular.

13. The tubing string of claim 1, wherein:
the coating is made from an electrically insulating material,
the conductor comprises a second tubular coating made from an electrically conductive material, and
the tubing string further comprises a third tubular coating extending at least essentially the length of the tubular and made from an electrically insulating material,
wherein the second coating is disposed between the coating and the third coating.

14. The tubing string of claim 13, wherein the electrically conductive material is a metal or alloy filled polymer composite.

15. The tubing string of claim 13, further comprising an electrically conductive wire bonded to the inner surface by the coating.

16. The tubing string of claim 13, further comprising:
a fourth tubular coating extending at least essentially the length of the tubular and made from an electrically conductive material; and
a fifth tubular coating extending at least essentially the length of the tubular and made from an electrically insulating material,
wherein the fourth coating is disposed between third and fifth coatings.

17. The tubing string of claim 1, wherein the tubular is made from a metal or alloy.

18. The tubing string of claim 17, wherein the tubular is continuous and the length is at least one thousand feet.

19. The tubing string of claim 18, wherein:
the conduit houses the wire,
the tubing string further comprises a coupling longitudinally and torsionally connected to each end of the tubular, and
the coupling is operable to be longitudinally and torsionally connected to a mating coupling and electrically connect the conductor to a conductor of the mating coupling.

20. The tubing string of claim 19,wherein each coupling comprises:
a diverter made from a polymer and having a port therethrough, the conductor passing through the port,
a mandrel connected to the diverter and having a sealed electrical connector receiving the conductor, and
one of a pin and box fastened to the mandrel and having a threaded surface matable with a threaded surface of the other of the pin and box:

21. The tubing string of claim 1, wherein the coating is made from an electrically insulating material.

22. The tubing string of claim 1, wherein the coating is made from an electrically conductive material.

23. A tubing string for use in a wellbore, comprising:
a tubular;
a first tubular coating extending a length of the tubular and made from an electrically conductive material; and
a second tubular coating extending the length of the tubular and made from an electrically insulating material,
wherein the first coating is disposed between the second coating and an inner surface of the tubular.

24. The tubing string of claim 23, wherein:
the tubular is made from a metal or alloy,
the tubing string further comprises a third tubular coating extending the length of the tubular and made from an electrically insulating material, and
the first coating is disposed between the second and third coatings.

25. The tubing string of claim 24, wherein the tubular is continuous and has a length of at least one thousand feet.

26. A method for bonding a conductor to an inner surface of a tubular, comprising:
pumping a volume of coating in front of a pig; and
propelling the pig through the tubular, wherein the pig applies the coating to the inner surface having at least a portion of the conductor laid thereon.

27. The method of claim 26, further comprising laying the conductor portion by propelling a spool pig through the tubular.

28. The method of claim 26, wherein the pig is a trail pig of a pigtrain, the pigtrain further comprises a spool pig, and the pigtrain is propelled through the tubular.

29. The method of claim 26, wherein:
the conductor portion is a conduit, and
the method further comprises inserting an optical cable or wire and/or an electrical cable or wire through the conduit.

30. The method of claim 26, wherein a thickness of the coating is substantially less than an outer diameter of the conduit portion.

31. The method of claim 30, further comprising applying one or more additional layers of the coating so that an aggregate thickness of the coating is substantially equal to the outer diameter.

32. The method of claim 26, wherein the tubular is made from a metal or alloy.

33. The method of claim 26, wherein the tubular is continuous and has a length of at least one thousand feet.

34. A method for forming a conductor along an inner surface of a tubular, comprising:
pumping a volume of coating in front of a pig; and
propelling the pig through the tubular,
wherein the pig applies the coating to the inner surface and the coating is electrically conductive.

35. The method of claim 34, wherein:
the tubular is made from a metal or alloy,
the method further comprises applying second and third coatings to the inner surface,
the second and third coatings are electrically insulating, and
the first coating is disposed between the second and third coatings.

36. The method of claim 35, wherein the tubular is continuous and has a length of at least one thousand feet.

37. A spool pig for use in a coiled tubing string, comprising:
a nose;
a tail;
a mandrel connected to the nose and tail; and
a spool disposed on the mandrel and rotatable relative to the mandrel.

38. The spool pig of claim 37, further comprising a tensioner operable to dampen rotation of the spool relative to the mandrel.

39. The spool pig of claim 37, further comprising a bearing connecting the spool to the mandrel and allowing relative rotation of the spool relative to the mandrel.

40. The spool pig of claim 37, wherein the nose and tail are seals for engaging an inner surface of the coiled tubing string.
